(19) United States
(12) Patent Application Publication
(10) Pub. No.: US 2004/0205254 A1
(43) Pub. Date: Oct. 14, 2004

(54) System for media capture and processing and method thereof

(76) Inventor: Stephen J. Orr, Markham (CA)

Correspondence Address: VEDDER PRICE KAUFMAN & KAMMHOLZ, 222 N. LASALLE STREET, CHICAGO, IL, 60601, US

(21) Appl. No.: 10/411,814

(22) Filed: Apr. 11, 2003

(51) Int. Cl. G06F 3/00

(52) U.S. Cl. 710/1

(57) ABSTRACT

A media capture device and processing system includes a media input port capable of receiving an incoming media signal. The media capture device further includes a bus interface connector coupleable to a bi-directional graphics bus. The media capture device also includes a media decoder, which is coupled to the media input wherein the media decoder is capable of receiving a media signal from the media input port. The media decoder is further capable of providing an output media signal to an integrated processor across the bi-directional graphics bus without using any data transfer protocols of the graphics bus, wherein the output media signal may be acquired by the integrated processor.

### FIELD OF THE INVENTION

The present invention relates generally to media processing and more particularly to media capturing with respect to a media processing device.

### BACKGROUND OF THE INVENTION

With the growth of computing devices, such as desktop and/or personal computers, using chip sets having graphics processors integrated therein, the ability to add multimedia functionality within a packaged computing system is becoming limited. Most prepackaged computer systems are sold with an integrated motherboard having a central processor and a graphics processor disposed therein. In order to install a media card, such as the All-in-Wonder Card manufactured by ATI Technologies, Inc., the graphics processor on the integrated motherboard must first be disabled so that the graphics add-in card can replace the graphics processor and add further multimedia functionality. This solution incurs extra costs to a system by a difficult installation process that may make it difficult for users to configure their computing system.

FIG. 1 illustrates a prior art graphics processing system 100 having a central processing unit (CPU) 102, and accelerated graphics port (AGP) graphics processor and northbridge 104 and a southbridge 106. The AGP graphics processor and northbridge 104 is coupled to a UMA memory interface 108 via connection 110. Furthermore, the AGP graphics processor and northbridge 104 is coupled to an AGP port 112 via a graphics bus 114 and a plurality of peripheral component interconnect (PCI) ports 116, 118 and 120 via a PCI bus 122.

In one embodiment, the graphics processor and northbridge 104 receives inputs from either the UMA memory interface 108, a device connected to the AGP port 112 or a component connected to one of the PCI ports 116, 118 and 120. The graphics processor and northbridge 104 thereupon provides the received data to the CPU 102 via a system bus 124, whereas the graphics processor of the graphics processor and northbridge 104 may perform graphics processing prior to transmitting the data to the CPU 102. As recognized by one having ordinary skill in the art, the CPU 102 further is capable of providing data back to the graphics processor and northbridge 104 across the system bus 124.

The CPU 102 is further coupled to the southbridge 106 via a system bus 126 such that the southbridge 106 may transmit or receive information from the CPU 102 and further provide audio output 128 or an input/output (I/O) connection 130.

FIG. 2 illustrates a prior art media capture device 200, such as the All-in-Wonder, manufactured by ATI Technologies, Inc. The media capture device 200 includes a tuner 202, a graphics processor 204, a memory 206 and a media decoder 208. The media capture device 200 receives an input via an input connector 210 and is further coupleable to a PCI port, such as 116 of FIG. 1, across a PCI bus connector 212. The media capture device 200 operates in accordance with known media capturing technology wherein an input signal may be provided to the tuner 202 and thereupon to the graphics processor 204 via a bus 214, which may be an I²C bus, a VIP bus or any other bus as recognized by one having ordinary skill in the art. In one embodiment, the media decoder 208 may further be coupled to bus 214 for added functionality, as recognized by one having ordinary skill in the art.

The tuner 202 is further coupled to the media decoder 208 via a bus 216 for providing video information to be decoded. The media decoder 208 is coupled to the graphics processor 204 across 222. The graphics processor 204 is further coupled to the memory 206 via a bus 218, and the graphics processor 204 is capable of providing data to the PCI bus connector 212 via a bus 220.

Other media capture cards, such as 200, are commercially available having varying levels of complexity through allowing for various user inputs and embedded processing abilities. For example, a media capture card may provide solely for receiving an incoming television signal, such as found in the ATI TV Wonder, available from ATI Technologies, Inc. The media capture card receiving the incoming television signal may contain a tuner, video decoder and audio decoder such that the incoming television signal may be acquired. Similar to the media capture card 200 of FIG. 2, the media capture card also utilizes a PCI bus connector for providing the acquired television signal to a central processing system across the PCI bus 122.

A proposed solution is the utilization of a PCI bus-mastering card, such as the media capture device 200, which may be connected to a PCI slot, such as slot 116. This media capture device 200 provides video input and the ability for demultiplexing an input signal using the tuner 202. As the number of PCI slots is limited, it is not advantageous to dedicate one of the PCI slots (e.g. port 116) for the media capture device 200. Furthermore, the utilization of the media capture device 200 across the PCI bus 122 has bandwidth limitations in that other PCI components connected to other PCI ports, such as ports 118 and 120, must share the PCI bus 122, which reduces system efficiency.

Another proposed solution for overcoming the current limitations is the utilization of an integrated graphics processor that multiplexes various output signals, such as a television output or a DVI signal, onto an AGP bus, such as bus 114. Riser cards have been developed for coupling to the AGP port 112 to take advantage of the AGP bus 114 bandwidth and to add additional functionality without requiring the addition of a new graphics card. However, these proposed solutions are limited by being output only and do not support inbound video or any bi-directional control across the AGP bus 114.

Therefore, there currently exists a need for media capture devices and media capture processing systems that can be easily implemented in conjunction with existing integrated processors, are not limited by PCI bus bandwidth limitations, and allow for bi-directional control.

### BRIEF DESCRIPTION OF THE DRAWINGS

FIG. 1 illustrates a schematic block diagram of a prior art computer processing system;

FIG. 2 illustrates a schematic block diagram of a prior art video capture card;

FIG. 3 illustrates a schematic block diagram of a media capture device and media processing system in accordance with one embodiment of the present invention;

FIG. 4 illustrates a schematic block diagram of an alternate media capture device and media processing system in accordance with another embodiment of the present invention;

FIG. 5 illustrates a flowchart of a method for media capturing in accordance with one embodiment of the present invention;

FIG. 6 illustrates another flow chart of another method for media capturing in accordance with one embodiment of the present invention; and

FIG. 7 illustrates a flow chart of an alternate method for media capturing in accordance with one embodiment of the present invention.

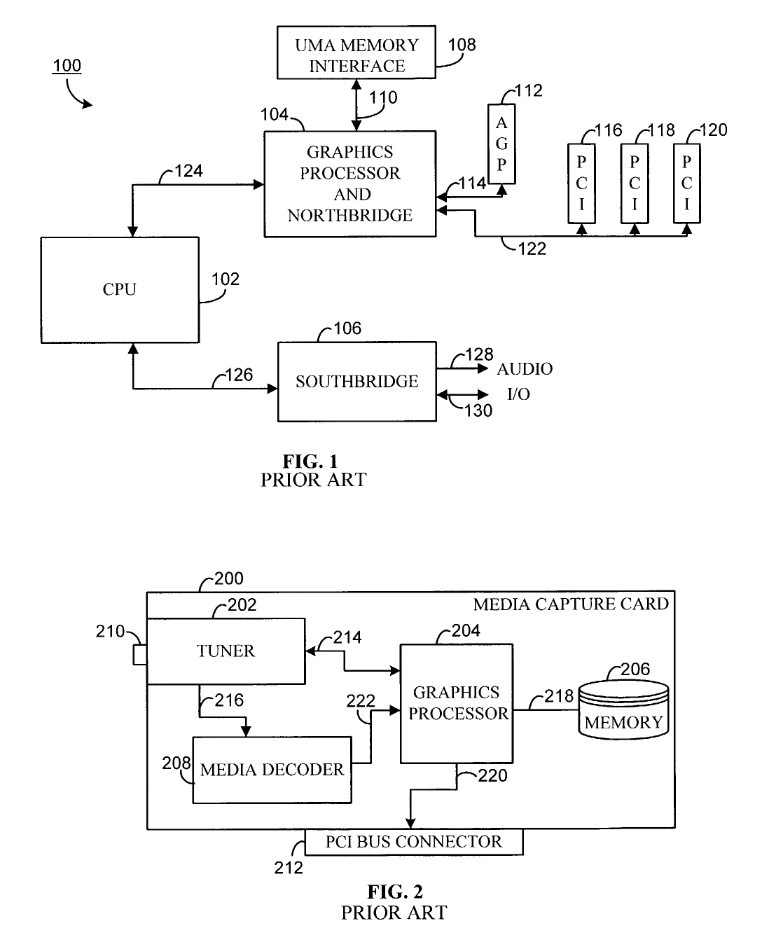

### DETAILED DESCRIPTION OF A PREFERRED EMBODIMENT

Briefly, a media capture device includes a media input port capable of receiving an incoming media signal. The media input port may be any type of input connector such as, but not limited to, a multi-pin input connector, a serial connector, or any other suitable port capable of receiving an incoming media signal, as recognized as one having ordinary skill in the art. Furthermore, an incoming media signal may be any type of signal containing audio, video, text, or any other type of media. The media capture device further includes a graphics bus connector, which may be coupled to a graphics bus. The graphics bus connector may be any suitable type of connector capable of providing for the connection of the media capture device to the graphics bus, such as, but not limited to, a physical connector having a plurality of contacts, one or more memory modules for data transfer, or any other suitable interface to allow coupling of the media capture device to a graphics bus, as recognized by one having ordinary skill in the art. Furthermore, the graphics bus may be any type of bus having a low voltage specification allowing for data transfers at increased frequencies with a high data throughput and allowing for deeply pipelined memory read and write operations and demultiplexing of address and data on the bus for improved efficiency. Moreover, the graphics bus is capable of being utilized in a manner outside of the original intended purpose, such as an AGP bus without utilizing the AGP bus transfer protocols and specifically excluding the utilization of a PCI bus due to the PCI bus being shared by multiple peripheral devices. Furthermore, in normal operations, the graphics bus has predefined data transfer protocols utilized to facilitate data transfer thereacross. The graphics bus of the present invention provides for data transfer without using the graphics bus predefined data transfer protocols, but rather provides a hard-wired physical pathway for data transmission.

The media capture device also includes a media decoder coupled to the media input wherein the media decoder is capable of receiving a media signal from the media input port. A media decoder is any suitable decoder, as recognized by one having ordinary skill in the art, capable of decoding the input media signal and parsing or de-multiplexing elements therefrom. In one embodiment, the media decoder may be the ATI Theater 200, available from ATI Technologies, Inc. Within the media capture device, the media decoder is further capable of providing an output media signal to an integrated processor across the graphics bus wherein the output media signal may be acquired by the integrated processor. The integrated processor may include any type of processor, such as an integrated AGP graphics processor, northbridge or other type of processing unit as recognized by one having ordinary skill in the art.

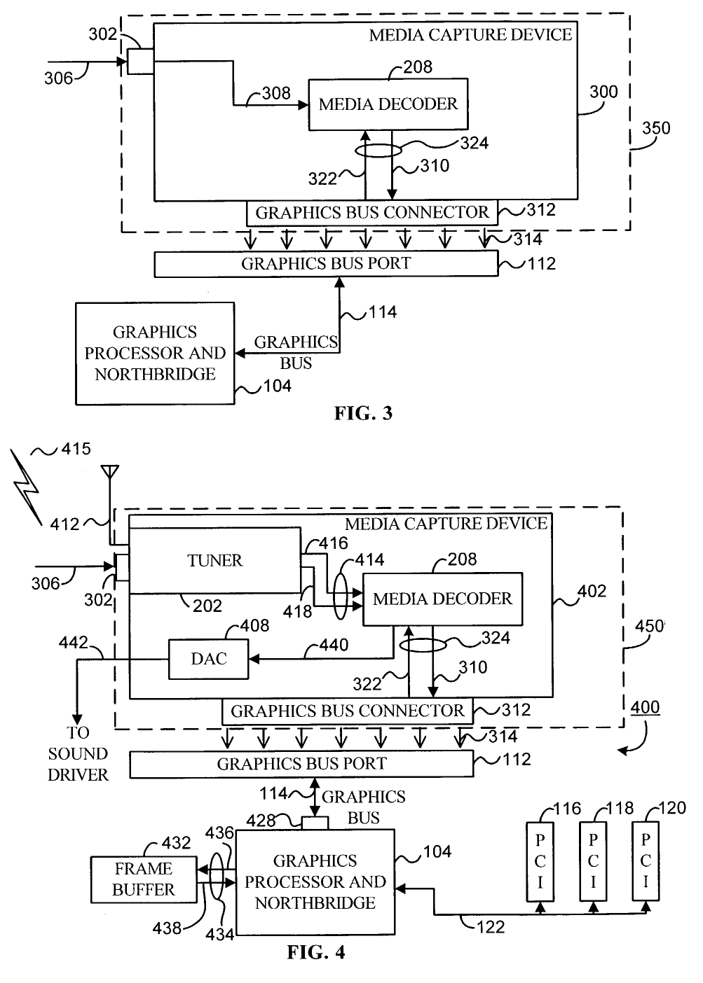

More specifically, FIG. 3 illustrates one embodiment of a media capture device 300 having a media input port 302 and the media decoder 208. As recognized by one having ordinary skill in the art, the media capture device 300 may contain further elements not illustrated herein that have been omitted for clarity purposes only. The media input port 302 is capable of receiving an incoming media signal 306 and providing therein a media signal 308 to the media decoder 208. Media decoder 208 decodes the media signal 308 and therein provides an output media signal 310 to a graphics bus connector 312.

The graphics bus connector 312 in the media capture device 300 is coupleable 314 to the graphics bus port 112. The graphics bus port 112 is operably coupled to the graphics processor and northbridge 104 via the graphics bus 114. Furthermore, the graphics bus 114 is a bi-directional bus; therefore the graphics processor and northbridge 104 may provide a command signal 322 to the media decoder 208 through the graphics bus 114 and across the graphics bus connector 312. In one embodiment, signals 310 and 322 may be transmitted across an internal bus 324, which may be an 1²C bus.

In one embodiment of the present invention, the media capture device 300 may be coupled to the graphics bus port 112, whereupon the media decoder 208 may provide the output media signal 310 to the graphics processor and northbridge 104 across the graphics bus 114, such that the output media signal 310 may be acquired therein.

One aspect of the present invention is the utilization of the graphics bus 114 without using graphics bus 114 requirements. The media capture device 300 utilizes the graphics bus 114, more specifically the hard-wired electrical connectors (wires, paths, leads) that make up the graphics bus 114, but does not use the graphics bus 114 in accordance with its intended purpose. Rather, any data transfer across the graphics bus 114, which is a bi-directional bus, relies on the physical bus connections and is not dictated by any graphics bus data transfer protocols. For example, if the graphics bus 114 is an AGP bus, AGP data transfer protocols, such as Master and Slave designations, are not required to facilitate data transfer therethrough.

FIG. 3 further illustrates that, in accordance with one embodiment of the present invention, the media capture device 300 may be disposed within an add-on card 350. The add-on card 350 may be any suitable combination of elements that may be coupled to a larger processing system, including, but not limited to, a riser card, a slot card, a plurality of embedded components on an existing processing system or card, or any other suitable combination of elements, as recognized by one having ordinary skill in the art, wherein the add-on card 350 may augment an existing computing system. In one embodiment, the add-on card 350 includes the media input port 302, media decoder 208, the internal bus 324 and the graphics bus connector 312. Furthermore, as recognized by one having ordinary skill in the art, the add-on card 350 may include further elements, which have been omitted for clarity purposes only.

FIG. 4 illustrates a media capture processing system 400 including a preferred embodiment of a media capture device 402. The media capture device 402 includes the tuner 202, the media decoder 208, a digital-to-analog converted (DAC) 408 and the graphics bus connector 312. Moreover, the media decoder 208 is capable of decoding an audio input and a video input. As recognized by one having ordinary skill in the art, the system 400 may contain further elements not illustrated herein, which have been omitted for clarity purposes only. The tuner 202 includes an antenna 412 capable of receiving a wireless signal 415, such as a wireless transmitted analog television signal, but as recognized by one having ordinary skill in the art, the media capture device 402 may include further input ports, such as the input port 302, capable of providing different types of media input signals, such as signal 306 which may be, but not limited to, an analog television broadcast signal, a component video signal, or a base band video signal via a composite and/or S-Video input connection (not illustrated).

The tuner 202 operates in accordance with known tuner operations and is disposed between the incoming media signal, such as signal 306 or 415, and the media decoder 208. The tuner 202 receives the incoming media signal (e.g. signal 306 or 415) and thereupon generates the media signal 414 provided to the media decoder 208. In the preferred embodiment, the tuner 202 is compatible to receive one or more of the standard television signal formats, including PAL, NTSC and/or SECAM, and variants thereof. In one embodiment, the media signal 414 includes a baseband analog video signal 416 and an audio signal 418. As recognized by one having ordinary skill in the art, based on the different types of media input signals, the media signal 414 may contain further media types beyond those disclosed herein.

In one embodiment, the media decoder 208 thereupon provides the media output signal 310 to the graphics bus connector 312, whereupon the graphics bus connector 312 may be coupled 314 to the graphics bus port 112, wherein the graphics bus port 112 provides for the coupling of the media capture device 402 to a graphics bus 114. When the incoming signal 306 is a base band video signal, the media output signal 310 represents the digital format, uncompressed raw video, of the analog video signal 416.

The graphics bus 114 is operably coupled to a Digital Video Stream (DVS) port 428, also known as a video input (VIP) port or a sideport, of the graphics processor and northbridge 104, wherein in the preferred embodiment, the DVS port 428 is a sideport. The graphics processor and northbridge 104 acquire the uncompressed raw video (310) provided across the graphics bus 114, herein referred to as media information 436. The graphics processor and northbridge 104 is further coupled to a frame buffer 432 via a bus 434 for writing the media information 436 to the frame buffer 432 and thereupon reading media information 438 therefrom. Furthermore, in one embodiment, the graphics processor and northbridge 104 is coupled to the plurality of PCI slots, 116, 118 and 120, and the PCI bus 122.

In another embodiment, the media decoder 208 is operably coupled to the DAC 408. The DAC 408 thereupon provides an audio output 442 directly to a sound driver, such an audio card, wherein the audio output 442 may be a stereo audio signal, a mono audio signal, an SAP audio signal or any other suitable audio signal as recognized by one having ordinary skill in the art. In alternative embodiments, the DAC 408 may be specifically hard-wired from the media capture device 402 to a sound driver or may be specifically wired to a central processing unit (not shown) having capabilities for processing the audio output 442, or, the audio output 442 may be provided across the graphics bus connector 312 and further across the graphics bus 314 to the graphics processor and northbridge 104, whereupon the audio output 442 may be further provided to an internal audio processor. Regardless thereof, the system 400 utilizes the graphics bus 114 to improve processing efficiency by utilizing the graphics processor and northbridge 104 in conjunction with the media capture device 402.

Furthermore, the graphics bus 114 is a bi-directional bus; therefore, the graphics processor and northbridge 104 may provide a command signal 322 to the media decoder 208. As recognized by one having ordinary skill in the art, the signals 310 and 322 may be transmitted across a single bus 324, such as an I²C bus. Thereupon, the system 400 allows for bi-directional data transfer, for the improvement over the prior art uni-directional media output techniques.

FIG. 4 further illustrates that, in accordance with one embodiment of the present invention, the media capture device 402 may be disposed within an add-on card 450. The add-on card 450, similar to the add-on card 350, may be any suitable combination of elements that may be coupled to a larger processing system, including, but not limited to, a riser card, a slot card, a plurality of embedded components on an existing processing system or card, or any other suitable combination of elements, as recognized by one having ordinary skill in the art, wherein the add-on card 450 may augment an existing computing system. In another embodiment, the add-on card 450 further includes the tuner 202 and other elements that, as recognized by one having ordinary skill in the art, have been omitted for clarity purposes only.

The add-on card 450 of FIG. 4 is coupleable to the graphics bus 114 through the graphics bus connector 312 being coupled 314 into the graphics bus port 112. As discussed above, in one embodiment, the graphics bus 114 is an AGP bus. Whereupon, the add-on card 450 may operate in a similar manner as described above with respect to the operation of the media capture device 402. The add-on card 450 may further contain the DAC 408 and allow for coupling to the sound driver (not shown) to provide an audible output.

In an alternative embodiment of the present invention, the tuner 202 may be a digital television (DTV) ready tuner capable of capturing a compressed digital signal, such as an Advanced Television System (ATS) signal, an MPEG encoded signal or any other suitable signal as recognized by one having ordinary skill in the art. The digital stream may be provided across the graphics bus 114, such that it may be acquired by the graphics processor and northbridge 104.

Moreover, in another alternative embodiment, the tuner 202 may be an analog tuner capable of receiving radio broadcasts in various radio broadcast frequency bands, such as AM, FM, XM (satellite band). The tuner 202 may receive the audio and provide the either a sound card, a central processor or any other processing device capable of processing the audio signal, in accordance with any of the above noted embodiments.

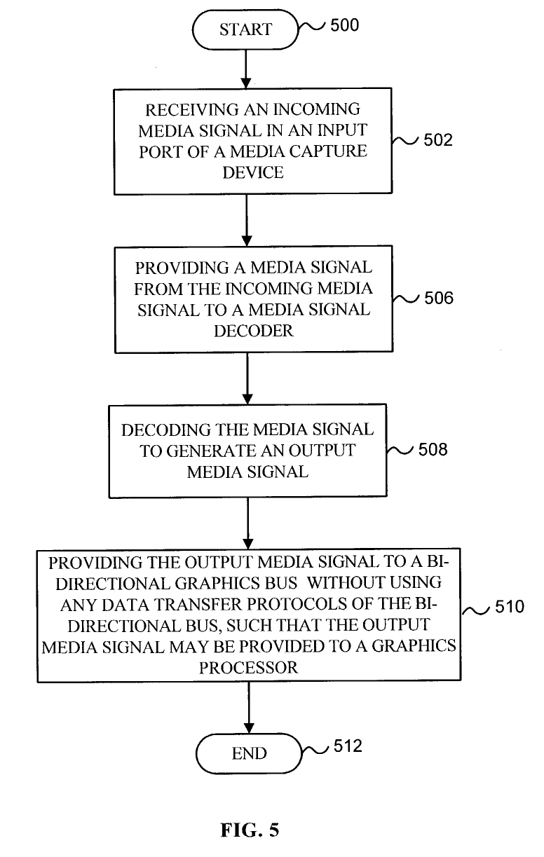

FIG. 5 illustrates a method for capturing a media signal, as discussed with respect to FIG. 3. The method begins, step 500, by receiving an incoming analog media signal in an input port of a media capture device, step 502. For example, the media input port 302 of the media captive device 300 receives the incoming analog media signal 306 such as a composite video signal, an S-Video signal, or Component Video signal in any of the standard formats for analog video such as NTSC, PAL, or SECAM. Thereupon, the analog media signal from the incoming media signal is provided to a media signal decoder, step 506, and an output digitized media signal is generated by decoding the analog media signal, step 508, such as the media decoder 208. In response thereto, the next step of the method is providing the output digitized media signal to a bi-directional graphics bus without using any data transfer protocols of the bi-directional graphics bus, such that the output digitized media signal may be provided to a graphics processor, step 510, such as the graphics processor and northbridge 104 coupled to the processor media decoder 208 across the graphics bus 114 through the graphics bus connector 312 and the graphics bus port 112. Thereupon, the method is complete, step 512.

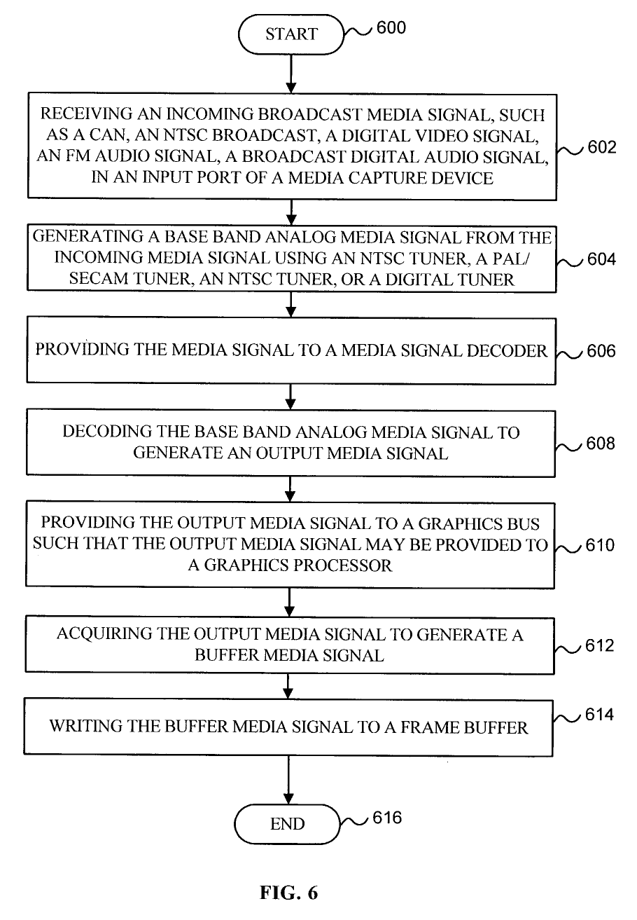

FIG. 6 illustrates an alternative method for capturing a media signal. The method begins, step 600, by receiving an incoming broadcast media signal, such as, but not limited to, a CATV broadcast, NTSC over-air broadcasts, a digital video signal, an FM audio signal, or a broadcast digital audio signal, in an input port of a media capture device, step 602. The next step, step 604, is generating a base band analog media signal from the incoming media signal using an NTSC tuner, a PAL/SECAM tuner, or a digital tuner.

The next step of the method is providing the base band analog media signal to a media signal decoder, step 606. Thereupon, the media signal is decoded to generate an output digitized media signal, step 608. The next step in the method, step 610, is providing the output digitized media signal to a graphics bus such that the output media signal may be provided to a graphics processor. Similar to step 510 of FIG. 5, the output media signal is transmitted across the graphics bus without using any data transfer protocols of the bus.

The next step, step 612, is processing the output media signal to generate a buffered media signal, such as the signal 436 illustrated in FIG. 4. The next step is writing the buffered media signal to a frame buffer, step 614, such as frame buffer 432 illustrated in FIG. 4. Thereupon, the method is complete, step 616.

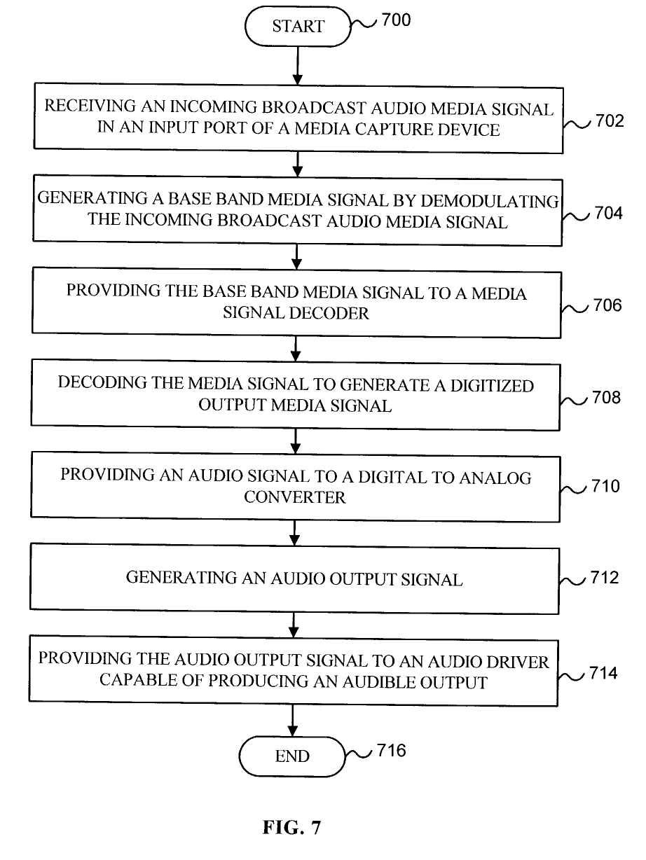

FIG. 7 illustrates another alternative embodiment of a method for capturing an audio media signal. The method begins, step 700, by receiving an incoming broadcast radio media signal in an input port of a media capture device, step 702. The next step, step 704, is demodulating that signal to generate a base band audio media signal from the incoming broadcast media signal.

Thereupon, the method includes providing the base band media signal to a media signal decoder, step 706. The next step is decoding the base band media signal to generate a digitized output media signal, step 708. Whereupon, an audio signal is provided to a digital-to-analog converter, step 710, such as signal 440 of FIG. 4 provided to DAC 408. As such, an audio output signal is generated, step 712, and the method includes providing the audio output signal to an audio driver capable of producing an audio output, step 714, such as signal 442 of FIG. 4. Thereupon, the method for media capture capturing a broadcast audio signal is complete, step 716.

Thereupon, the present invention provides for the improved data transfer and system efficiency through the facilitation of capturing the media input signal, such as signal 306, in a media capture device, such as 300, or in an add-on card, such as 350, and utilizing an existing graphics bus, such as 114, for providing decoded graphics data therethrough, such as 310. The present invention allows for a graphics processor, such as 104, within an existing computing system to be maintained, while augmenting a computing system's functionality through the addition of the media capture device, such as 300, or the add-on card, such as 350. The present invention overcomes prior art limitations by reducing costs through the removal of a graphics processor on the media capture device, such as 300, instead of the media capture card 200, which required that the disablement of the native graphics processor, such as 104, since these graphics processing was performed by the processor 204.

The present invention further improves over the prior art by utilizing an existing graphics bus to provide the hard-wired communication path between the media capture device, such as 300, or the add-on card, such as 350, and the graphics bus port 112. As discussed above, the prior art systems utilized multiple PCI slots, which require a processing system to allow the sharing of the PCI bus, such as 122, with multiple components coupled to PCI slots, such as 116-120. Alternatives for faster processing allow for utilization of other existing buses, such as graphics bus 114, which in one embodiment is the AGP bus. The present invention utilizes the hard-wired physical connections of the graphics bus, such as 114, without utilizing the data transfer protocols. In other words, the present invention utilizes existing hard-wired bus connections for data transfer not necessarily in accordance with the original intent of the graphics bus. Through the efficient usage of the graphics processor, such as 104, and by using the existing graphics bus, the present invention does not require any further redesign of a computing system and does not suffer from the lack of the use of graphics bus as a graphics bus since, graphics information is no longer processor on the media capture device, such as 300, or the add-on card, such as 350.

It should be understood that there exist implementations of other variations and modifications of the invention and its various aspects, as may be readily apparent to those of ordinary skill in the art, and that the invention is not limited by the specific embodiments described herein. For example, if a DVS port is capable of receiving higher bandwidth signals, a digital transport stream may be provided from an ATSC tuner and demodulator in a digital television system or other larger bit transport stream, such as a 16-bit transport stream with respect to I²C 8-bit stream. Furthermore, further components may be included on the add-on card, including a video-out port for providing an output video signal to another device in addition to the output provided across the graphics bus, such as a recording device, using a standard output connection as recognized by one having ordinary skill in the art. It is therefore contemplated to cover, by the present invention, any and all modifications, variations, or equivalents to fall within the spirit and scope of the basic underlying principles disclosed and claimed herein.

What is claimed is:

1. A media capture device comprising:
a media input port capable of receiving an incoming media signal;
a graphics bus connector operably coupleable to a bi-directional graphics bus; and
a media decoder operably coupled to the media input such that the media decoder is capable of receiving a base band media signal from the media input port and providing an output digitized media signal to a graphics processor across the graphics bus without using any data transfer protocols of the bi-directional graphics bus, such that the output digitized media signal may be acquired by the graphics processor.

2. The media capture device of claim 1 further comprising:
a tuner disposed between the media input port and the media decoder such that the tuner receives the incoming media signal and thereupon generates the baseband media signal that is provided to the media decoder.

3. The media capture device of claim 2 further comprising:
a digital to analog converter operably coupled to the media decoder such that an audio output signal may be provided thereto, wherein the digital to analog converter is operably coupleable to an audio driver capable of producing an audible output.

4. The media capture device of claim 2 wherein the tuner is at least one of: a CATV tuner, a PAL/SECAM tuner, an NTSC tuner, a radio tuner and a Digital TV tuner.

5. The media capture device of claim 2 wherein the incoming media signal is at least one of: a digital video signal, an analog audio signal, a digital audio signal, a component video signal and a composite video signal.

6. The media capture device of claim 1 wherein the graphics bus connector is operably coupleable to an accelerated graphics port (AGP) bus.

7. The media capture device of claim 1 wherein the graphics bus connector is operably coupleable to a graphics bus port.

8. A media processing system comprising:
a media capture device including:
a media input port capable of receiving an incoming media signal;
a graphics bus connector operably coupled to a bi-directional graphics bus; and
a media decoder operably coupled to the media input such that the media decoder is capable of receiving a media signal from the media input port and providing an output media signal to the graphics bus connector; and
a graphics processor operably coupled to the bi-directional graphics bus such when the graphics bus connector is coupled to the bi-directional graphics bus, the graphics processor is capable of acquiring the output media signal transmitted by media decoder without using any data transfer protocols of the bi-directional graphics bus.

9. The media processing system of claim 8 further comprising:
a northbridge operably coupled to the graphics bus; and
a frame buffer operably coupled to the northbridge.

10. The media processing system of claim 9 wherein the northbridge is disposed within the graphics processor and the graphics processor, upon acquiring the output media signal, stores the media signal to be provided in the frame buffer.

11. The media processing system of claim 10 wherein the graphics processor further includes a Digital Video Stream (DVS) port operably coupled to the graphics bus such that the graphics processor may receive the output media signal across the graphics bus.

12. The media processing system of claim 11 further comprising a graphics bus port operably coupling the graphics bus connector to the DVS port across the graphics bus.

13. The media processing system of claim 8 wherein the media capture device further comprises:
a tuner disposed between the media input port and the media decoder such that the tuner receives the incoming media signal and thereupon generates the media signal that is provided to the media decoder.

14. The media processing system of claim 13 wherein the media capture device further comprises:
a digital to analog converter operably coupled to the media decoder such that an audio output signal may be provided thereto, wherein the digital to analog converter is operably coupleable to an audio driver capable of producing an audible output.

15. The media processing system of claim 14 wherein the tuner is at least one of: a CATV tuner, a PAL/SECAM tuner, an NTSC tuner, a radio tuner and a Digital TV tuner.

16. The media processing system of claim 8 wherein the graphics bus is an accelerated graphics port bus.

17. The media processing system of claim 8 wherein the incoming media signal is at least one of: a digital video signal, an analog audio signal, a digital audio signal, a component video signal and a composite video signal.

18. A method for media capturing comprising:
receiving an incoming media signal in an input port of a media capture device;
generating a media signal from the incoming media signal;
providing the media signal to a media signal decoder;
decoding the media signal to generate an output media signal; and
providing the output media signal to a graphics bus without using any data transfer protocols of the bi-directional graphics bus, such that the output media signal may be acquired by a graphics processor.

19. The method of claim 18 further comprising:
coupling a graphics bus connector of the media capture device to a graphics bus port coupled to the graphics bus; and
providing the output media signal to the graphics processor through the graphics bus connector.

20. The method of claim 19 further comprising:
acquiring the output media signal to generate a buffer media signal; and
writing the buffer media signal to a frame buffer.

21. The method of claim 18 wherein the step of generating a media signal from the incoming media signal is performed by at least one of: a CATV tuner, a PAL/SECAM tuner, an NTSC tuner, a radio tuner and a Digital TV tuner.

22. The method of claim 18 wherein the incoming media signal is at least one of: a digital video signal, an analog audio signal, a digital audio signal, a component video signal and a composite video signal.

23. The method of claim 18 further comprising:
providing an audio signal to a digital to analog converter;
generating an audio output signal; and
providing the audio output signal to an audio driver capable of producing an audible output.

24. An add-on card comprising:
a media input port capable of receiving an incoming media signal;
a tuner operably coupled to the media input port such that the tuner receives the incoming media signal and thereupon generates a media signal;
a media decoder operably coupled to the tuner such that the media decoder receives the media signal from the tuner and generates an output media signal; and
a graphics bus connector operably coupled to the media decoder and being operably coupleable to a bi-directional graphics bus such that when the bus interface is coupled to the bi-directional graphics bus, the media decoder is operably coupled to an integrated processor across the graphics bus such that the output media signal may be acquired by the integrated processor.

25. The add-on card of claim 24 further comprising:
a digital to analog converter operably coupled to the media decoder such that an audio output signal may be provided thereto, wherein the digital to analog converter is operably coupleable to an audio driver capable of producing an audible output.

26. The add-on card of claim 24 wherein the bi-directional graphics bus is an accelerated graphics port bus and the graphics bus allows for bi-directional data transfer without using any of the plurality of AGP data transfer protocols.

27. A media capturing and processing system comprising:
a media capture device including:
a media input port capable of receiving an incoming media signal;
a tuner operably coupled to the media input port such that the tuner receives the incoming media signal and thereupon generates a media signal;
a media decoder operably coupled to the tuner such that the media decoder receives the media signal from the tuner and generates an output media signal; and
a bus interface connector operably coupled to the media decoder and being operably coupleable to a bi-directional graphics bus;
a graphics bus port capable of receiving the graphics bus connector and operably coupled the media capture device to the bi-directional graphics bus; and
a graphics processor operably coupled to the bi-directional graphics bus such that when the graphics bus connector is coupled to the graphics bus port, the graphics processor is capable of receiving the output media signal across the bi-directional graphics bus without using any data transfer protocols of the bi-directional graphics bus.

28. The system of claim 27 wherein the graphics processor further includes a DVS port operably coupled to the bi-directional graphics bus.

29. The system of claim 28 wherein the bi-directional graphics bus is an accelerated graphics port bus.
